(19) United States
(12) Patent Application Publication
(10) Pub. No.: US 2010/0274847 A1
(43) Pub. Date: Oct. 28, 2010

(54) System and method for remotely indicating a status of a user

(75) Inventors: Aubrey B. Anderson, San Francisco, CA (US); Jose Ericson R. de Jesus, San Francisco, CA (US); Cole J. Poelker, San Francisco, CA (US); Bruce D. McFarlane, San Francisco, CA (US); Reynaldo D. Flemings, San Francisco, CA (US)

Correspondence Address: DAVID LEWIS, 1250 AVIATION AVE., SUITE 200B, SAN JOSE, CA, 95110, US

(73) Assignee: Particle Programmatica, Inc.

(21) Appl. No.: 12/799,662

(22) Filed: Apr. 28, 2010

Related U.S. Application Data
(60) Provisional application No. 61/173,488, filed on Apr. 28, 2009.

(51) Int. Cl. G06F 15/16

(52) U.S. Cl. 709/203

(57) ABSTRACT

A system and method are provided for creating one or more dynamic visual representations of a user and sharing the dynamic visual representations with contacts of the user. The dynamic visual representations are created from video data captured by the user to indicate the status of the user such as an emotion of the user. The dynamic visual representations include video or image data that is displayed so as to give an appearance of motion. In some embodiments, a displayed dynamic visual representation is changed in response to an action by the user or an action by one of the contacts of the user. The dynamic visual representations may be simultaneously displayed for multiple users and may be used to create a visual component in a contact application such as an address book application.

### CROSS REFERENCE TO RELATED APPLICATIONS

This application is a utility application that claims priority benefit to U.S. Provisional Patent Application No. 61/173,488 (Attorney Docket # 100498-5002-PR) entitled “System and Method for Remotely Indicating a Status of a User” filed on Apr. 28, 2009, by Aubrey Anderson et al., which is incorporated herein by reference.

### FIELD

This specification generally relates to status notifications for electronic communication between users.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In recent years, electronic communications have become an increasingly important way for people to keep in touch with each other. Electronic communications now include not only audio and text communication but also pictures and video communications as well.

### SUMMARY

A system and method is provided for remotely indicating a status of a user that also provides a means for personalizing and increasing the accuracy of status notifications. In an embodiment, users are provided with a way to notify contacts of the users' current status using a dynamic visual representation of the user. In an embodiment, a user can create a personalized, status message by recording a facial expression reflecting the mood and/or emotion of the user. The user can also evaluate the status of contacts of the user by viewing the dynamic visual representations of the contacts. In an embodiment, this system and method facilitates communication between users by enabling users to use intuitive visual cues (e.g. hand expressions, facial expressions, and/or other body expression) of in-person communication to enhance electronic communications.

In some embodiments, a user can use a camera (e.g., a webcam) to create one or more dynamic visual representations, each of which may capture a different mood, emotion and/or other visual queue or message of the user. In an additional embodiment, the dynamic visual representations are a sequence of images displayed with sufficient rapidity so as to create the illusion of motion and continuity. These dynamic visual representations may be shared with contacts of the user by posting at least some of the dynamic visual representations on a website or sending an electronic message containing one or more of the dynamic visual representations to the contacts.

Any of the above embodiments may be used alone or together with one another in any combination and may also include embodiments that are only partially mentioned or alluded to or are not mentioned or alluded to at all in this brief summary or in the abstract.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates block diagram of an infrastructure of a computerized distributed system for remotely indicating a status of a user in accordance with some embodiments of the present invention.

FIG. 2 illustrates a block diagram of a dynamic visual representation server system for remotely indicating a status of a user in accordance with some embodiments of the present invention.

FIG. 3 illustrates a block diagram of a client system for creating video data and displaying dynamic visual representations in accordance with some embodiments of the present invention.

FIGS. 4A-4B illustrates a flow diagram of a method for providing a dynamic visual representation of a status of one or more users in accordance with some embodiments of the present invention.

FIGS. 5A-5C illustrates example of user interfaces for creating dynamic visual representations in accordance with some embodiments of the present invention.

FIG. 6A illustrates an example of a user interface for changing the current status of a user in accordance with some embodiments of the present invention.

FIG. 6B illustrates current dynamic visual representations of each of a plurality of contacts of a user simultaneously displayed in accordance with some embodiments of the present invention.

FIGS. 6C1 and 6C2 illustrate a contact application in the form of an address book application in accordance with some embodiments of the present invention.

FIG. 6D illustrates an example of a user interface for displaying additional contact information in accordance with some embodiments of the present invention.

FIG. 6E illustrates an example of a user interface for implementing a method for receiving a request to initiate communication from a second user in accordance with some embodiments of the present invention.

FIG. 6F illustrates a user interface for adjusting the settings of a computing device in accordance with some embodiments of the present invention.

FIG. 7 illustrates a flow diagram of a method of assembling a computerized distributed system in accordance with some embodiments of the present invention.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

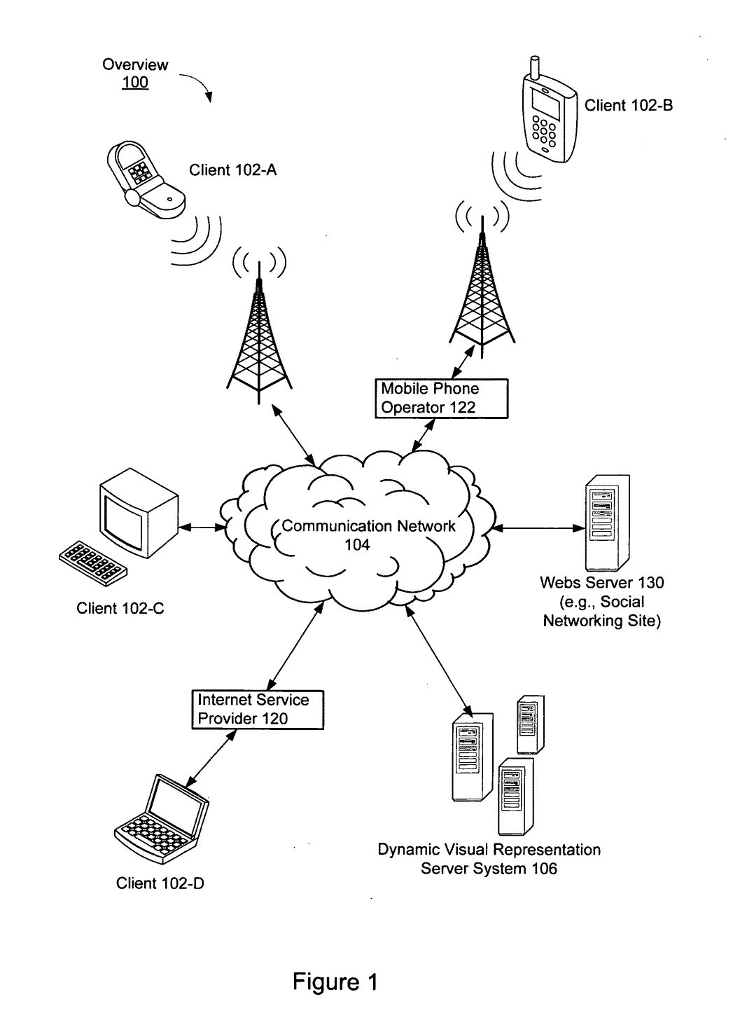

In general, at the beginning of the discussion of each of FIGS. 1-3 and 5A-6F is a brief description of each element, which may have no more than the name of each of the elements in the one of FIGS. 1-3 and 5A-6F that is being discussed. After the brief description of each element, each element is further discussed in numerical order. In general, each of FIGS. 1-7 is discussed in numerical order and the elements within FIGS. 1-7 are also usually discussed in numerical order to facilitate easily locating the discussion of a particular element. Nonetheless, there is no one location where all of the information of any element of FIGS. 1-7 is necessarily located. Unique information about any particular element or any other aspect of any of FIGS. 1-7 may be found in, or implied by, any part of the specification.

Any place in this specification where the term “user interface” is used a graphical user interface may be substituted to obtain a specific embodiment. Any place where the term “network” is used in this specification any of or any combination of the Internet, another Wide Area Network (WAN), a Local Area Network (LAN), wireless network, and/or telephone lines may be substituted to provide specific embodiments. It should be understood that any place where the word device appears the work system may be substituted and any place a single device, unit, or module is referenced a whole system of such devices, units, and modules may be substituted to obtain other embodiments.

FIG. 1 illustrates the infrastructure of a computerized client-server distributed system 100 for remotely indicating a status of a user in accordance to some embodiments of the present invention. The distributed system 100 may include a plurality of client systems 102 A-D, communications network 104, one or more dynamic visual representation server systems 106, one or more Internet service providers 120, one or more mobile phone operators 122 and one or more web servers 130, such as social networking sites. In other embodiments distributed system 100 may not have all of the elements or features listed and/or may have other elements or features instead of or in addition to those listed.

In an embodiment, using the distributed system 100 a first user places a phone call. The phone number is looked up in a database. Based on the phone number dialed, the database fetches the “emotional state,” which may be accompanied with other information, such as a location, information from latest web posts to Twitter, Flickr, or another web service. Then, the emotional stated and/or other information retrieved is displayed on the phone of the receiver of the call. The receiver of the call can then evaluate how to proceed. The process may occur concurrently, after or before the call. Although there are limitations to “before” the call as there is a limited amount of time for ringing and/or voicemail picks up. Additionally, a text message may be sent about emotional state without actually placing a phone call. The process may be used for all types of voice communications including non-traditional-Google® voice. The information provided can be described as “super describing” an individual and can be tied to any communication form. In an embodiment, the process uses software on the server and/or software on the receiving device with no requirement on the calling device. The emotional state information could be displayed on the receiving device or on a laptop and/or on another network enabled device (which may be referred to as a network) nearby. Google(r) voice allows multiple numbers (e.g., three) to be mapped to a single number. Dialing the single number (to which the other numbers are mapped) as mapped by Google voice causes the other devices to ring. Using the mapping, the emotional state and/or other information may be sent to each of the numbers mapped to the single number. The user may provide the most up to date current status that they choose to share. The information provided may identify the caller and/or receiver (in addition to and/or by identifying how the caller and/or receiver currently feels) and is kind of like a leaving a business card or calling card. Instead of a caller list, a user may have a list of avatars (e.g., a film about the person may be the person's avatar).

Regarding the distributed system 100, the current specification has determined that it has become increasingly important for users to keep the contacts of the users notified of the users' current status. Users often want to quickly determine the current status of the users' contacts. Knowing the current status of a contact may help the user determine whether to refrain from communicating with the contact or communicate with the contact based on the mood and/or emotion of the contact (for example, to find out why Contact A is sad). Similarly a user may see that Contact B is angry, and may refrain from communicating with Contact B until Contact B's status changes to a different status. Additionally, a user may want to inform a number of contacts of his or her current status without having to individually communicate with each of the contacts.

As defined herein, a dynamic visual representation (DVR) is a visual representation of a status of a user that may be displayed as a sequence of images which, when displayed with sufficient rapidity create the illusion of motion and continuity, which is known as animating a dynamic visual representation. In some embodiments, the dynamic visual representation is a video data, while in other embodiments the dynamic visual representation is a series of still images that are rapidly displayed so as appear to be a video image. The dynamic visual representation is created using image or video data captured and/or scanned by the user. In some embodiments, the dynamic visual representations include short videos or a series of consecutive images of a user. In some embodiments this may include expressions on the face of a user or other expressive elements in addition to or instead of the face of the user involving a user's hands, body, nearby objects or other expressive elements. These expressions and other elements may display an emotional state and/or mood of the user. For example, a user may frown and dab his eyes with a handkerchief to indicate that his emotional state is sad or a user may be waving his or her hands around to indicate that user is excited or a user may put the head of the user on a pillow to indicate that the user is sleepy. In this specification any place a DVR is mentioned, another indication of the status of the user may be used instead of, or in addition to, the DVR to obtain an alternative embodiment.

In some embodiments, these expressions and other elements are captured in real time so as to represent the current emotional state of the user. For example, if a user is currently crying, the user may capture an image or video of the user crying. In other embodiments, the user may capture expressions that are representative of an emotional state of the user that is not the current emotional state of the user. In these embodiments, the user may then select a dynamic visual representation that is representative of the current emotional state of the user from a set of dynamic visual representations of previously captured expressions. In some embodiments, a dynamic visual representation additionally includes displaying one or more words in conjunction with the dynamic visual representation where words are indicative of the status associated with the dynamic visual representation. For example, a dynamic visual representation of a user crying may include the text “sad”, a dynamic visual representation of a user waving her hands around may include the text “excited”. Thus the textual labels may help a user to distinguish the emotional state of a contact if the dynamic visual representation is otherwise ambiguous. For example, a dynamic visual representation may show a contact waving his hands around and the text may explain that the mood of the contact is “hyper”, rather than “angry,” “excited,” or “annoyed”. In some embodiments, the user's contacts may also create dynamic visual representations similar to the dynamic visual representation created by the user. The user may have an application that collects at least some of the dynamic visual representations and displays them to the user. This application may be an address book application that runs on a cell phone or other portable electronic device. In such an address book application, the user would be able to view the emotional states of those contacts simply by looking at the dynamic visual representations of one or more of the contacts in the address book application. The user may choose to initiate (or avoid initiating) communication with one of the contacts based on the emotional state displayed in the dynamic visual representation of the contact. If the user decides to call the contact, a dynamic visual representation of the user may be sent to the contact as the phone call is being connected. In some embodiments, each user sees the dynamic visual representation of the other user before the call is connected. In an embodiment, the conversation between the two users may start with the exchange of dynamic visual representations, and each user may start out the conversation knowing the status of the other user (e.g., the first user may send a status indicator to the second user indicating that the first user is happy and the second user may send a status indicator to the first user indicating that the second user is stressed). An additional application of these dynamic visual representations is to enhance the interactivity of some web applications. For example, an online invitation sent to the user could display a dynamic visual representation showing the current emotional state of the host, an RSVP of “no” from the user would result in the display of a “sad” dynamic visual representation, while an RSVP of “yes” from the user would result in the display of a “happy” dynamic visual representation.

Distributed system 100 provides a means for personalizing and increasing the accuracy of status notifications. Users are provided with a way to notify their contacts of their current status using a dynamic visual representation of the user. In an embodiment, using distributed system 100, a user can quickly create a personalized, accurate status message by recording a facial expression.

A client system 102, also known as a client device, client computing device or client computer, may be any computer or similar device that is capable of receiving from the DVR server system 106 web pages, displaying data, sending requests, such as web page requests, search queries, information requests, login requests and other sending requests, to the DVR server system 106, the Internet service provider 120, the mobile phone operator 122 or the web server 130. Examples of suitable client devices 102 include desktop computers, notebook computers, tablet computers, mobile devices such as mobile phones, personal digital assistants and set-top boxes and other client devices. In the present application, the term “web page” means virtually any data, such as text, image, audio, video, JAVA scripts and other data that may be used by a web browser or other client application programs. Requests from a client system 102 may be conveyed to a respective DVR server system 106 using the HTTP protocol and using HTTP requests. In some embodiments, client systems 102 may be connected to the communication network 104 using cables such as wires, optical fibers and other transmission mediums. In other embodiments, client systems 102 may be connected to the communication network 104 through one or more wireless networks using radio signals or other wireless technology.

One or more networks 104 may be any of or any combination of the Internet, another Wide Area Network (WAN), a Local Area Network (LAN), wireless network, and/or telephone lines may be substituted to provide specific embodiments. The plurality of client systems 102 A-D, one or more dynamic visual representation server systems 106, one or more Internet service providers 120, one or more mobile phone operators 122 and one or more web servers 130 may be linked together through one or more communication networks 104, such as the Internet, other wide area networks, local area networks and other communications networks, so that the various components can communicate with each other.

In some embodiments, one or more DVR server systems 106 may be a single server. In other embodiments the DVR server systems 106 include a plurality of servers, such as a web interface (front end) server, one or more application servers, and one or more database servers which are connected to each other through a network, such as a LAN, a WAN or other network, and exchange information with the client systems 102 through a common interface, such as one or more web servers, which are also called front end servers. In some embodiments, the servers are located at different locations. The front end server parses requests from the client systems 102, fetches corresponding web pages or other data from the application server and returns the web pages or other data to the requesting client systems 102. Depending upon the respective locations of the web interface and the application server in the topology of the client-server system, the web interface and the application server may also be referred to as a front end server and a back end server in some embodiments. In some other embodiments, the front end server and the back end server are merged into one software application or hosted on one physical server.

The distributed system 100 may also include one or more additional components which are connected to the DVR servers systems 106 and the clients 102 through the communication network 104. The Internet service provider 120 may provide access to the communication network 104 to one or more of the client devices 102. The Internet service provider 120 may also provide a user of one of the clients 102 with one or more network communication accounts, such as an e-mail account or a user account for utilizing the features of system 100. The mobile phone operator 122 also provides access to the network to various client devices 102. In some embodiments, the mobile phone operator 122 is a cell phone network or other hardwire or wireless communication provider that provides information to the DVR server system 106 and the client system 102 through the communication network 104. In some embodiments, the information provided by the mobile phone operator 122 includes information about the network communication accounts associated with one or more of the clients 102 or one or more users of the clients 102. For example, where the service provider 122 is a mobile phone network operator, the service provider 122 may provide information about the cell phone number of one or more users of a cell phone network.

Additionally, in some embodiments, the web server 130 is a social networking site or the like. In these embodiments, a user of one of the client devices 102 has an account with the social networking site that includes at least one unique user identifier. In accordance with some embodiments, contacts of the user are provided with a unique user identifier and other relevant network communication account information by the DVR server system 106. In some embodiments, at least a portion of the account information is stored locally on the client device 102.

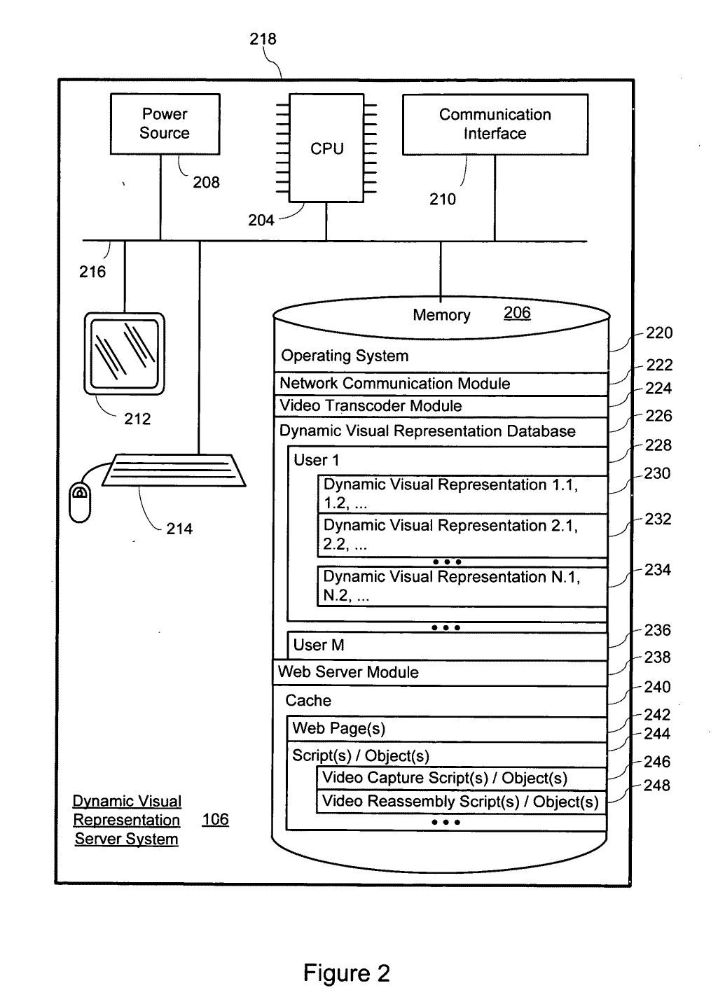

FIG. 2 is a block diagram illustrating a DVR server system 106 in accordance with one embodiment of the present invention. The DVR server system 106 may include one or more central processing units (CPUs) 204, memory 206, one or more power sources 208, one or more network or other communication interface 210, one or more output devices 212, one or more input devices 214, one or more communication buses 216, and housing 218. Memory 206 may store the following programs, modules, and data structures, or any subset of an, operating system 220, a network communication module 222, a video transcoder module 224, a dynamic visual representation database 226, user 228 (which is User 1), a plurality dynamic visual representations 230, 232, 234, user 236 (which is User M), a web server module 238, cache 240 having web pages 242, and scripts and/or objects 244, video capture scripts and/or objects 246, and video reassembly scripts and/or objects 248. In other embodiments DVR server system 106 may not have all of the elements or features listed and/or may have other elements or features instead of or in addition to those listed.

The processing unit 204 may include any one of, some of, or any combination of multiple parallel processors, a single processor, a system of processors having one or more central processors and/or one or more specialized processors dedicated to specific tasks. The processing units may also include one or more digital signal processors (DSPs) in addition to or in place of one or more CPUs and/or may have one or more digital signal processing programs that run on one or more CPU 204.

Memory 206 may include a storage device that is integral with the server, and/or may optionally include one or more storage devices remotely located from the CPU(s) 204. The memory 206, or alternately the non-volatile memory device(s) within the memory 206 may also have a machine readable medium such as a computer readable storage medium. The memory 206 may include high-speed random access memory, such as DRAM, SRAM, DDR RAM or other random access solid state memory devices and may include non-volatile memory, such as one or more magnetic disk storage devices, optical disk storage devices, flash memory devices or other non-volatile solid state storage devices.

Power sources 208 may include a plug, battery, an adapter, and/or power supply for supplying electrical power to the elements of DVR server 106. One or more network or other communication interface 210 may include an interface for connecting to network 104.

Output devices 212 may include a display device, and input devices 214 may include a keyboard and/or pointing device, such as a mouse, track ball, or touch pad. Input devices 214 may include any one of, some of, any combination of, or all of an overall keyboard system, a mouse system, a track ball system, a track pad system, buttons on a handheld system, a scanner system, a microphone system, a connection to a sound system, and/or a connection and/or interface system to a computer system, intranet, and/or Internet, such as IrDA or USB. The DVR server system 106 optionally may include a user interface with one or more output devices 212 and one or more input devices 214.

One or more communication buses 216 communicatively connect one or more central processing units (CPUs) 204, memory 206, one or more power sources 208, one or more network or other communication interface 210, one or more output devices 212, one or more input devices 214 to one another. Housing 218 house and protects the components of DVR server 106.

Operating system 220 may include procedures for handling various basic system services and for performing hardware dependent tasks. Network communication module 222 may be used for connecting the DVR server system 106 to other computers via the hardwired or wireless communication network interfaces 210 and one or more communication networks 104, such as the Internet, other wide area networks, local area networks, metropolitan area networks and other communications networks. Video transcoder module 224 transcodes video data into one or more dynamic visual representations. In some embodiments, the video data may be transcoded into a plurality of dynamic visual representations, and each of the plurality of dynamic visual representations may have a distinct data format. Dynamic visual representation database 226 may store a plurality dynamic visual representations 230, 232, 234 for a plurality of users 228, 236 (which are labeled Users 1-M), where some of the dynamic visual representations 230, 232, 234 were generated by the video transcoder module 224. In some embodiments, each dynamic visual representation 230,232,234 is associated with a particular status of a particular user and may optionally be stored in a plurality of formats, such as flash video, MPEG, animated GIF, a series of JPEG images or other formats. Web server module 238 serves web pages 242 and scripts and/or objects 244, video capture scripts and/or objects 246, and video reassembly scripts and/or objects 248 to client devices 102. Cache 240 stores temporary files on the DVR server system 106. In some embodiments, the temporary files stored in cache 240 include video data received from a client system 102 that is cached while the video transcoder module 224 is creating dynamic visual representations 230, 232, 234 based on the video data.

Each of the above identified programs, modules and/or data structures may be stored in one or more of the previously mentioned memory devices and correspond to a set of instructions for performing the functions described above. The above identified modules, programs and sets of instructions need not be implemented as separate software programs, procedures or modules and thus various subsets of these modules may be combined or otherwise rearranged in various embodiments. In some embodiments, the memory 206 may store a subset of the modules and data structures identified above. Furthermore, the memory 206 may store additional modules and data structures not described above.

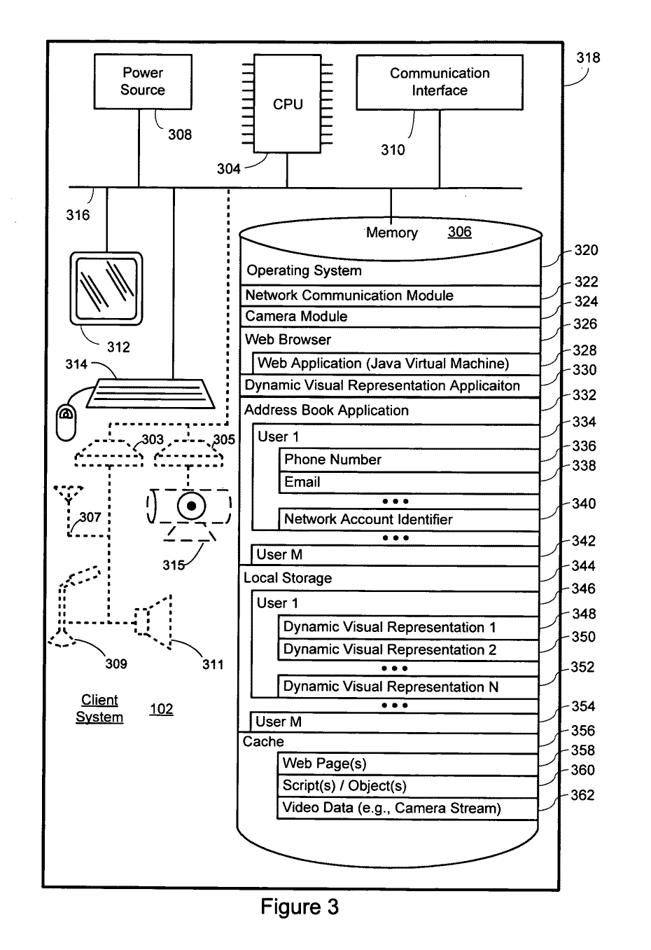

FIG. 3 is a block diagram illustrating a client system 102, also referred to as a client device or client computing device, in accordance with one embodiment. The client system 102 may include sound card 303, one or more central processing units (CPUs) 304, video card 305, memory 306, antenna 307, one or more power sources 308, microphone 309, and one or more network or other communications interfaces 310. The client system 102 optionally may include, receiver 311, one or more of output device 312, input device 314, and camera 315. The client system 102 optionally may include one or more communication buses 316 for interconnecting these components and a housing 318. In some embodiments, memory 306 or the computer readable storage medium of the memory 306 stores one or more of, any combination of, and/or any subset of an operating system 320, a network communication module 322, a camera module 324, a web browser 326, a dynamic visual representation application 330, an optional address book application 332, that displays contact information for the contacts of the user 334, 342, such as phone numbers 336, e-mail addresses 338, network account identifiers 340, optional local storage 344, which may include one or more dynamic visual representations 348, 350, 352 associated with one or more users 346, 352, a cache 356, a web page 358, scripts and/or objects 360, and video data 362. In other embodiments client system 102 may not have all of the elements or features listed and/or may have other elements or features instead of or in addition to those listed.

The client system of FIG. 3 may be any of the user systems of FIG. 1. In an embodiment, sound card 303 may include components for processing audio signals. In an embodiment, sound card 303 may process audio signals via a digital to analog converter, which converts data of a digital format to data of an analog format, and vice versa.

The processing unit 304 (similar to processor unit 204) may include any one of, some of, or any combination of multiple parallel processors, a single processor, a system of processors having one or more central processors and/or one or more specialized processors dedicated to specific tasks. The processing units may also include one or more digital signal processors (DSPs) in addition to or in place of one or more CPUs and/or may have one or more digital signal processing programs that run on one or more CPU 204.

In an embodiment, video card 305 may include components for processing visual data and/or converting visual data to a digital format and vice versa.

Memory 306 may include high-speed random access memory, such as DRAM, SRAM, DDR RAM or other random access solid state memory devices and may include non-volatile memory, such as one or more magnetic disk storage devices, optical disk storage devices, flash memory devices or other non-volatile solid state storage devices. Memory 306 may optionally include one or more storage devices remotely located from the CPU(s) 304.

The memory 306, or alternately the non-volatile memory device(s) within the memory 306, also includes a machine-readable medium such as a computer readable storage medium. Input devices other than a keyboard 314 can be used and may include any one of, some of, any combination of, or all of an overall keyboard system, a mouse system, a track ball system, a track pad system, buttons on a handheld system, a scanner system, a microphone system, a connection to a sound system, and/or a connection and/or interface system to a computer system, intranet, and/or Internet, such as IrDA or USB.

Antenna 307 may transmit and/or receive electromagnetic waves carrying wireless communications, such as phone calls and/or messages to and from network 104. One or more power sources 308 may include a plug, battery, an adapter, and/or power supply for supplying electrical power to the elements of client system 102. Microphone 309 may be used for receiving sound generated by the client, such as part of a phone conversation. Microphone 309 may send signals generated by the sound to sound card 305 for converting the sound signals into a format for processing by CPUs 204 and stored, for example. One or more network or other communications interfaces 310 may include an interface for connecting network 104. Speaker 311 may produce sounds, such as those generated during a phone message and/or while creating a DVR. Speakers 311 may be linked to the rest of client system 102 via sound card 305.

Output devices 312 may include a display device or other input device, and input devices 314 may include a keyboard and/or pointing device, such as a mouse, track ball, or touch pad. Input devices 314 may include any one of, some of, any combination of, or all of an overall keyboard system, a mouse system, a track ball system, a track pad system, buttons on a handheld system, a scanner system, a microphone system, a connection to a sound system, and/or a connection and/or interface system to a computer system, intranet, and/or Internet, such as IrDA or USB. Client system 102 may include a user interface with one or more output devices 212 and one or more input devices 214.

In some embodiments, the camera 315 is a video camera, such as a webcam. In some embodiments, the camera 315 is integrated into the client system 102, while in other embodiments the camera 315 is separate from the client system 102. Signals produced from images received by camera 315 may be placed into a format appropriate for processing via CPU 304 and stored, via sound card 303.

The client system 102 optionally may include one or more communication buses 316 for interconnecting these components and a housing 318. Power sources 208 may include a plug, battery, an adapter, and/or power supply for supplying electrical power to the elements of client system 102. One or more network or other communication interface 210 may include an interface for connecting to a network.

One or more communication buses 316 communicatively connect one or more central processing units (CPUs) 304, memory 306, one or more power sources 308, one or more network or other communication interface 310, one or more output devices 312, one or more input devices 314 to one another. Housing 318 house and protects the components of client system.

Operating system 320 may include procedures for handling various basic system services and for performing hardware dependent tasks. Network communication module 322 may be used for connecting the client system 102 to other computers via the one or more hardwired or wireless communication network interfaces 310 and one or more communication networks 104, such as the Internet, other wide area networks, local area networks, metropolitan area networks and other communications networks in the art.

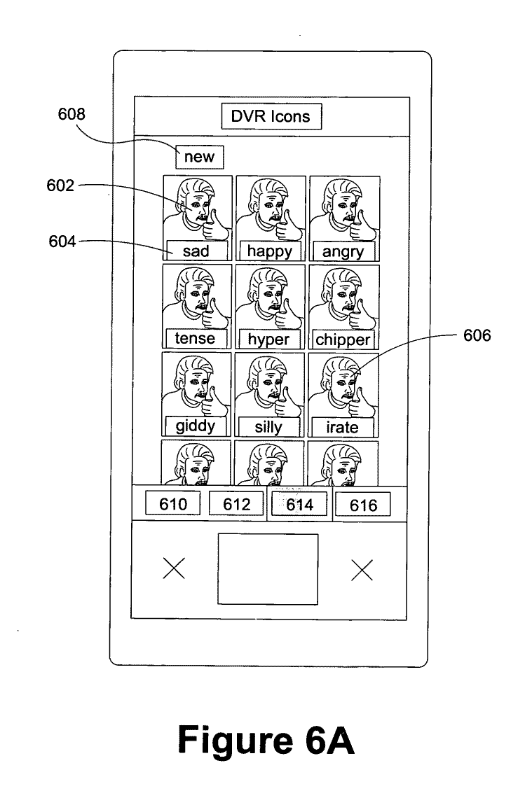

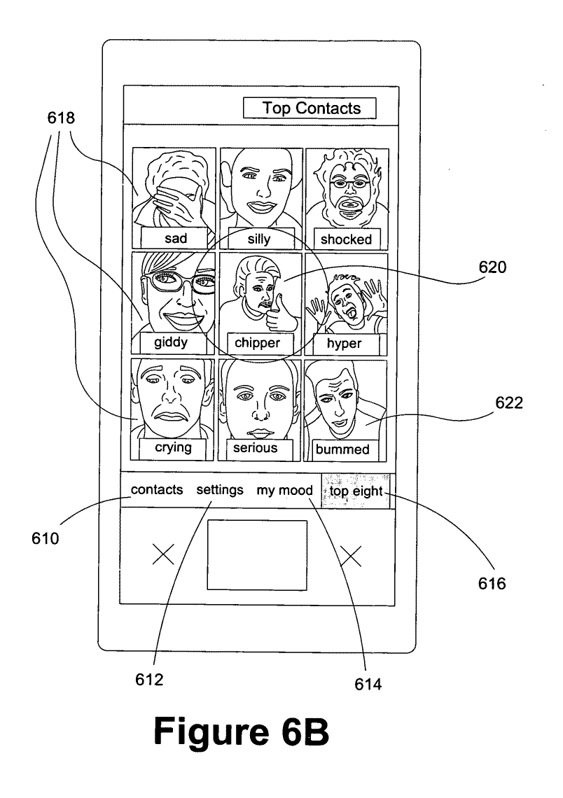

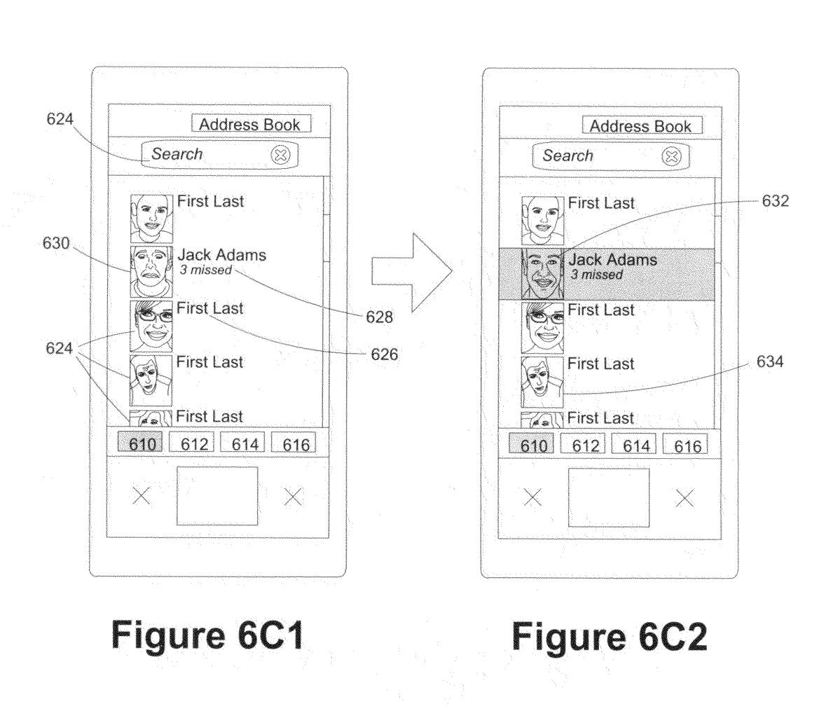

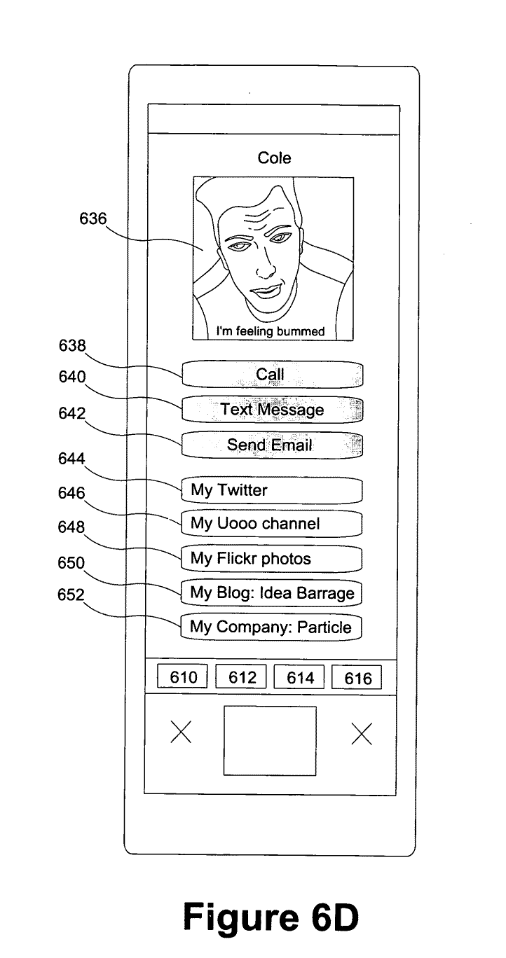

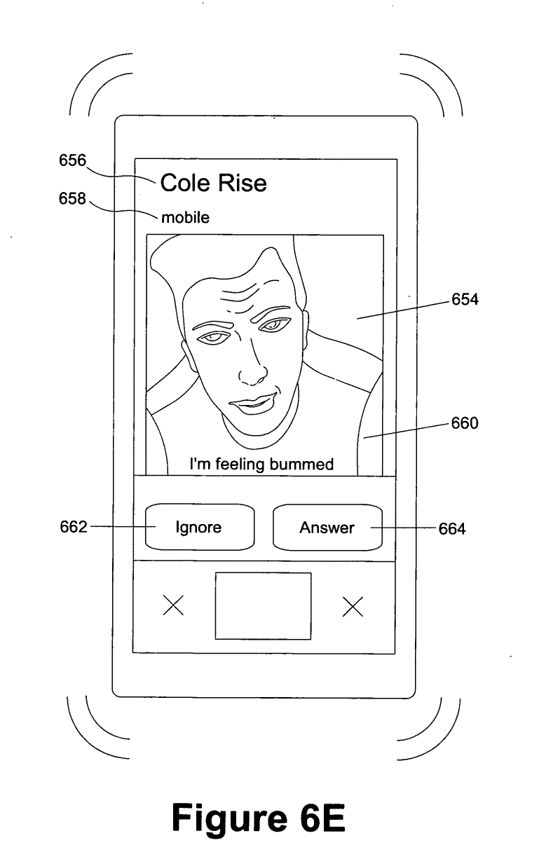

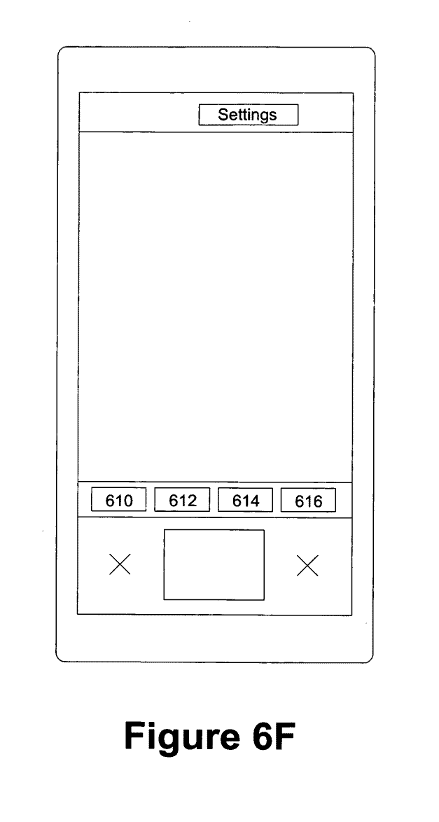

Camera module 324 may include instructions for receiving input from a camera 315 attached to the client system 106 and creating video data that is representative of the input from the camera 315. Web browser 326 may receive a user request for a web page and may render the requested web page on the display device 312 or other user interface device. Web browser 326 may also include a web application 328, such as a JAVA virtual machine for the execution of JAVA scripts 360. Dynamic visual representation application 330 may display dynamic visual representations of a user and the user's contacts. Dynamic visual representation application 330 may allow the user to perform operations relating to the dynamic visual representations, such as selecting a current status and adding or deleting a dynamic visual representation. Dynamic visual representation 330 is described in greater detail in conjunction with FIGS. 6A-6F. Optional address book application 332 may display contact information for the contacts of the user 334, 342, such as phone numbers 336, e-mail addresses 338, network account identifiers 340, such as a user name for a social networking website of a user. In some embodiments at least a subset of the contact information is displayed along with a dynamic visual representation for one or more of the users, as described in greater detail in conjunction with FIG. 6C, below. Optional local storage 344 may include one or more dynamic visual representations 348, 350, 352 associated with one or more users 346, 352. In some embodiments the users include both the contacts of a user and the user of the client device 102, while in other embodiments, dynamic visual representations of other users may be stored in local storage 344 as well. Cache 356 may store temporary files on the client system 102. In some embodiments the cache 356 includes one or more of data for use in rendering a web page 358 in the web browser 326, scripts and/or objects 360, such as JAVA script, for execution by the processor 304 and video data 362, such as streaming video from the camera 315.

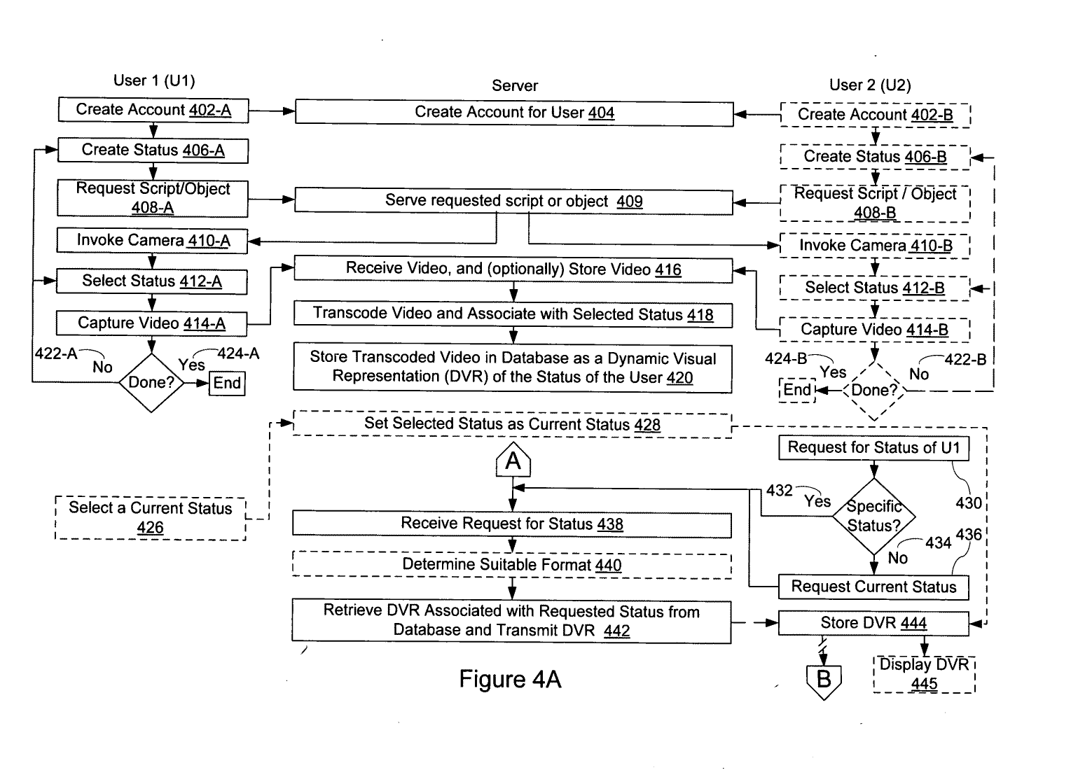

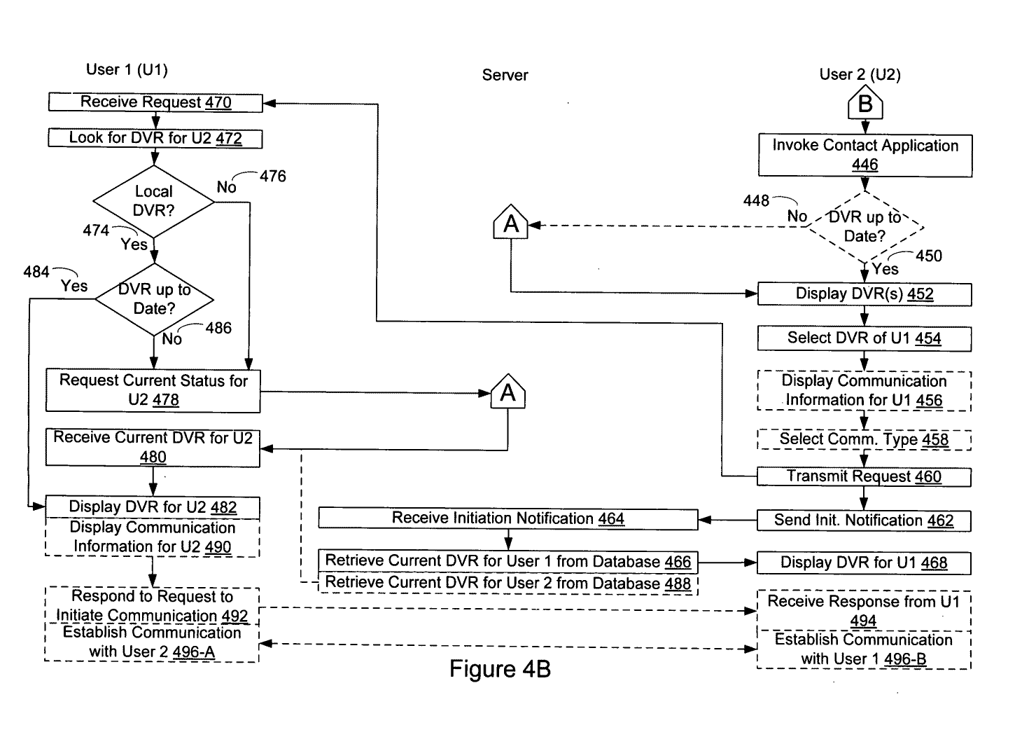

FIGS. 4A and 4B contain a flowchart representing a method for providing a dynamic visual representation of a status of one or more users, according to certain embodiments. The method of FIGS. 4A and 4B may be governed by instructions that are stored in a computer readable storage medium and that are executed by one or more processors of one or more servers. Each of the operations shown in FIG. 4A may correspond to instructions stored in a computer memory or computer readable storage medium. The computer readable storage medium may include a magnetic or optical disk storage device and solid state storage devices, such as flash memory or other non-volatile memory device or devices. The computer readable instructions stored on the computer readable storage medium are in source code, assembly language code, object code or other instruction format that is interpreted by one or more processors.

In some embodiments, a first user of a first computing device initiates the creation of an account associated with the first user in step 402-A. For example, the user may access a website and follow account creation procedures for selecting a user identifier and a password. The user may also input contact information for the first user such as one or more phone numbers, an e-mail address and other network account information, such as a social networking website user identifier. After receiving the contact information from the user the server creates a user account for the first user in step 404 and associates the account with the selected user identifier. In some embodiments, the server stores information about the user in a dynamic visual representation database 226. The data associated with the user 228, includes one or more dynamic visual representations 230, 232, 234, 234 (FIG. 2). The first user then creates one or more status indicators in step 406-A. For example, status indicators may indicate an emotional state of a user, such as sad, silly, shocked, giddy, chipper, hyper, crying, serious, bummed, happy, excited, stressed, irate or other emotions. Additionally a status indicator may be used to indicate a physical state of a user, such as being asleep or being awake or to indicate a current activity, such as eating dinner, watching a movie, or another activity. In some embodiments, the user may be presented with a set of standard statuses.

In some embodiments, the first computing device requests a script and/or object from the server in step 408-A. The server serves the requested script and/or object to the requesting computing device in step 409 and the script and/or object begins the process of capturing video data from a camera 315 (FIG. 3) that is associated with the first computing device. In some embodiments, the script/object, camera module/driver or client invokes the camera in step 410-A which in some embodiments is a webcam. A user is then directed to select and enter a status in step 412-A. Video data to be associated with the selected status is then captured in step 414-A (FIG. 4A) by the camera.

In FIG. 4A, the captured video is sent to the DVR server system 106, which may optionally store the video/images in a cache or in local storage for later use in step 416. In addition to transferring the video data, the selected status of the user is also transmitted to the DVR server system. In some embodiments, at least a predefined portion of the captured video data is transcoded by the server and associated with the status selected by the user in step 418. As used herein transcoding means conversion of a file or a data stream from a first file compression format or streaming protocol to a second file compression format or format for storing captured data, where the first file compression format or data stream is distinct from the second file compression format or format for storing captured data. In some embodiments, the entire video data is transcoded while in other embodiments, a predefined portion of the video data equal to a predefined length of time is transcoded. In some embodiments, transcoding at least a predefined portion of the video data includes encoding the predefined portion of the video data as a video file. For example, the video data may be encoded into a compressed format such as flash video, MPEG, WMV, AVI or other compressed format.

In some embodiments, transcoding at least a predefined portion of the video data includes extracting a consecutive series of frames from the predefined portion of the video data and storing the frames on the DVR server system as separate image files, such as JPEGs, TIFFs, GIFs or other separate image files. In some embodiments, the video frames may be stored in a compressed format such as JPEG. In some embodiments, the frames are configured to be sent to a computing system, the computing system may include a script/object that is run on the computing system to animate any image files sent to the computing system. In some embodiments, the video frames may be used to create an animated GIF. In some embodiments, each dynamic visual representation has an associated time stamp indicating the date and time the dynamic visual representation was created. In some embodiments, the time stamp may be displayed to a user viewing the dynamic visual representation.

The transcoded video data is stored in the dynamic visual representation database as a dynamic visual representation of a particular status of the user in step 420 that submitted the video data, as previously described. In some embodiments, the dynamic visual representation is associated with a status of a user. After capturing the video data in step 414-A, the first user may have the option of beginning the process again to capture other dynamic visual representations representing a different status of the user. If the first user indicates recording is not finished following decision branch 422-A, then the process loops back to a previous step, such as creating a status 406-A or selecting a status 412-A. This allows the user to create a new status or select a previously created or default status and capture video data associated with that status. In some embodiments, a user may replace a dynamic visual representation by simply selecting a status that is already associated with another dynamic visual representation.

In some embodiments, if a user selects a status that is already associated with a dynamic visual representation, a warning is displayed indicating that the previously associated dynamic visual representation will be deleted. In some embodiments, multiple dynamic visual representations, each of which is associated with a distinct status of the first user are created. If the first user indicates that recording is finished following decision branch 424-A, then the loop ends. As described previously, the dynamic visual representations created by the first user are stored on the DVR server system for later access by the user in step 420. In some embodiments, a user need not create all of the dynamic visual representations in a single session. Rather, the user may log out of the user account and subsequently log back into the user account and initiate the process by creating a status in step 406, to create new dynamic visual representations, as previously described. In some embodiments, the DVR server system obtains, from a second computing device associated with a second user, multiple dynamic visual representations, each of which is associated with a distinct status of the second user (and stores the dynamic visual representation obtained). Operations 402-B through 424-B illustrate an example of a substantially identical process for one or more additional users to create dynamic visual representations. In another embodiment, the first user selects his or her current status in step 426. In some embodiments, selecting a status as a current status updates the time stamp on the dynamic visual representation associated with the status. For example, a user may create a happy status, a sad status and an angry status and then when the user selects the happy status as the current status of the user, the time that the user selected the happy status is the timestamp of the status. The timestamp for a status provides contacts of the user with information about how recently a user changed his or her status. For example, if a user changed his or her current status to a sad status on September 1st and it is now December 5th, it is unlikely that the status still accurately reflects the emotional state of the user.

In some embodiments, when a status is selected by the user, the server sets the status selected by the user as the current status in step 428.

Returning to FIG. 4A, in some embodiments, a second user requests a status of a first user in step 430. In some embodiments, the request for a status is automatically generated when the user performs a predefined action, such as accessing a web page with an embedded link to the dynamic visual representation of the first user or opening an address book application containing a link to a dynamic visual representation of the first user. In some embodiments, the request for a status is generated manually by the second user by selecting a link on a web page or selecting an address book entry in an address book. In some embodiments, the request for status is sent for multiple users simultaneously, such as a request to update the dynamic visual representation for each user in an address book. In some embodiments, the request includes a request for a specific status of the first user in step 432. For example, a web page may indicate that the sad dynamic visual representation of a user is to be displayed in the web page. In some embodiments, the request does not include a request for a specific status of the first user, such as in step 434. When the request does not include a request for a specific status of the first user, the status of the first user is requested in step 436, which will be treated as a request for the current status of the first user.

The DVR server system receives the status request from the computing device associated with the second user in step 438 and in response to the status request selects a dynamic visual representation associated with a status of the first user indicated by the status request. In some embodiments, each status is associated with multiple formats of the same dynamic visual representation, such as a flash video file, an MPEG file, an animated GIF, and/or a series of JPEG images.

In some embodiments, the status request from the client device 102 includes an indication of the capabilities of the computing device. In some embodiments, the status request includes an indication of the capabilities of the computing device, the DVR server system 106 uses the indicated capabilities of the computing device to determine a suitable format for the selected dynamic visual representation in step 440. In some embodiments, a suitable format is determined by the rendering capabilities of the hardware or software used by the computing device. For example, a particular cellular phone may not be able to display flash animation, therefore the phone must be sent a dynamic visual representation in a file format that is not flash video.

In some embodiments, the suitable format is determined based on the connection speed of the computing device to the DVR server system 106. For example, for a computing device that is connected to the DVR server system 106 using a slow connection, a low resolution dynamic visual representation might be determined as the most suitable, whereas for a computing device that is connected to the DVR server system 106 using a fast connection, a high resolution dynamic visual representation might be determined as the most suitable. In some embodiments, the indicated capabilities of the computing device are communicated by the computing device along with the status request. In some embodiments, the indicated capabilities of the computing device are inferred by the DVR server system 106 from the communication. For example, if a user's web browser is mobile Safari, then the computing device is most likely an iPhone™ and if the web browser is the BlackBerry™ web browser, then the device is most likely a BlackBerry™ device.

The selected dynamic visual representation is then retrieved from the database and is sent to the computing device associated with the second user in step 442. The computing device associated with the second user stores the dynamic visual representation in step 444. In some embodiments, the computing device associated with the second user also displays the dynamic visual representation in step 445. In some embodiments, the dynamic visual representation is not immediately displayed.

With reference to FIG. 4B, in some embodiments, the second user invokes a contact application in step 446, such as an address book application. The computing device may then check to determine whether the dynamic visual representations in the contact application are up to date. In some embodiments, the computing device checks for updates to the dynamic visual representations on a predetermined schedule, such as once a day. In some embodiments, the computing device checks for updates to the dynamic visual representations only when the contact application is invoked. In one embodiment, a dynamic visual representation is determined to be up to date if the dynamic visual representation has a time stamp that indicates that the dynamic visual representation was updated within a predefined time period, such as a dynamic visual representation being current if the dynamic visual representation was updated less than 30 minutes ago. In some embodiments, the predefined time period is determined by the user. It should be understood that there are alternative ways of determining whether a dynamic visual representation is up to date. In some embodiments, a computing device checks for updates to a dynamic visual representation only if the current dynamic visual representation of a user is requested. In some embodiments, a computing device checks for updates to the dynamic visual representation when a specific dynamic visual representation is requested. In some embodiments, the criteria used to determine whether a dynamic visual representation is up to date are selected based on whether a current dynamic visual representation or a specific dynamic visual representation is requested. For example, a specific dynamic visual representation may be up to date if that dynamic visual representation was checked for updates in the last week, while the current dynamic visual representation is not up to date unless the dynamic visual representation was checked for updates in the last hour.

In some embodiments, if at least one of the dynamic visual representations is not up to date following decision branch 448, the computing device associated with the second computer sends a request to the DVR server system for an updated dynamic visual representation, which is received by the DVR server system in step 438 (FIG. 4A). In some embodiments, if all of the dynamic visual representations are up to date following decision branch 450 then one or more of the dynamic visual representations are displayed on the computing device in step 452. In some embodiments only a subset of the dynamic visual representations need to be up to date before the dynamic visual representations are displayed. If for some reason, it is not possible to update one or more of the dynamic visual representations, the dynamic visual representations stored in the computing device are used. In this embodiment, the user may be notified that one or more out of date dynamic visual representations are being displayed.

It should be understood that dynamic visual representations may be displayed in a variety of different ways. In virtually any instance where there is a buddy icon, avatar, profile picture or other visual symbol that is associated with the user, the dynamic virtual representation may be displayed, such as a buddy icon displayed in an instant message as an avatar on a plurality of discussion boards and a profile picture on social networking websites or on any web page. In some embodiments, users are provided with downloadable dynamic visual representations that may be inserted into web pages or e-mails. In some embodiments, users are provided with HTML code for inserting a link to the dynamic visual representation that is hosted on the DVR server system 106.

Returning to FIG. 4B, after the dynamic visual representations are displayed in step 452 as previously discussed, the second user selects the dynamic visual representation of the first user in step 454. In some embodiments, additional communication information is displayed for the first user in step 456. A communication type is selected from communication information in step 458. Once the user has selected a dynamic visual representation of the first user in step 454 and selected a communication type from communication information in step 458, the request to initiate communication with the first user is transmitted from the second computing device associated with the second user to the first computing device associated with the first user in step 460. In some embodiments, the request to initiate communication is transmitted over a mobile network, such as a cellular network or a wireless network. In some embodiments, in conjunction with transmitting the request to initiate communication, the second computing device sends an initiation notification to the DVR server system in step 462. The initiation notification indicates that the second user is attempting to initiate communication with the first user. The DVR server system receives the initiation notification from the second user in step 464 indicating that the second user has attempted to initiate communication with the first user and in response to the initiation notification, the DVR server system retrieves and displays a dynamic visual representation of the first user from the database in step 466 and transmits the dynamic visual representation of the first user to the second computing device for display to the second user. In some embodiments, the second computing device displays the received dynamic visual representation of the first user in step 468. In some embodiments, the received dynamic visual representation is displayed prior to receiving any response from the first user and prior to establishing communication with the user. For example, the second user may dial a phone number of the first user and before being connected to the first user, receive a current dynamic visual representation of the first user from the DVR server system 106. In this way, the second user is provided with additional information about the status and current emotional state of the first user before the call is connected.

In some embodiments, the first computing device associated with the first user receives a request to initiate communication from the second computing device in step 470. In response to receiving the request, the first computing device looks for a dynamic visual representation of the second user in its local storage. In some embodiments, the first computing device looks for a specific dynamic visual representation of the second user, such as the dynamic visual representation associated with the current status of the second user. In other embodiments the first computing device looks for the most recently updated dynamic visual representation of the second user. If the first computing device finds a locally stored dynamic visual representation of the second user in step 474, the first computing device checks to see if the locally stored dynamic visual representation is up to date. If the first computing device does not find a locally stored dynamic visual representation following decision branch 476, then the first computing device sends a request to the DVR server system for an up to date dynamic visual representation of the second user in step 478, such as a dynamic visual representation associated with the current status of the user. The DVR server system receives the request and sends the requested dynamic visual representation of the second user to the first computing device in step 438. The requested dynamic visual representation of the second user is received by the first computing device in step 480. In some embodiments, the received dynamic visual representation of the second user is displayed on the first computing device in step 482.

When a locally stored dynamic visual representation of the second user is found by the first computing device following decision branch 474, the first computing device checks to see if the dynamic visual representation of the second user is up to date. If the locally stored dynamic visual representation of the second user is up to date following decision branch 484 then the first computing device displays the dynamic visual representation of the second user in step 482. If the locally stored dynamic visual representation of the second user is not up to date following decision branch 486, then the first computing device sends a request to the DVR server system for an up to date dynamic visual representation of the second user in step 478, such as a dynamic visual representation associated with the current status of the user. The DVR server system receives the request and sends the requested dynamic visual representation of the second user to the first computing device in step 438. The requested dynamic visual representation of the second user is received by the first computing device in step 480. In some embodiments, the received dynamic visual representation of the second user is displayed on the first computing device in step 482.

In some embodiments, in response to receiving an initiation notification from the second user indicating that the second user is attempting to initiate communication with the first user, the DVR server system retrieves a current dynamic visual representation of the second user from the database in step 488 and sends the dynamic visual representation of the second user to the first computing device for display to the first user. In some embodiments, sending the dynamic visual representation of the second user to the first computing device is performed in conjunction with sending the dynamic visual representation of the first user to the second computing device. The sent dynamic visual representation of the second user is received by the first computing device in step 480. In some embodiments, the received dynamic visual representation of the second user is displayed on the first computing device in step 482.

In some embodiments, additional communication information associated with the second user is displayed in conjunction with the dynamic visual representation of the second user following decision branch 486. The additional communication information associated with the second user may include some or all of the additional contact information that will be described in greater detail in conjunction with FIG. 6D, below.

Returning back to FIG. 4B, the user may respond to the request to initiate communication received from the second computing device in step 492. The second computing device receives the response in step 494. In some embodiments, the second user is notified of the response from the user. In some embodiments, the response from the user is an acceptance of the request and a communication channel is established between the first user in step 496-A, and the second user in step 496-B.

In an embodiment, each of the steps of method of FIGS. 4A and 4B is a distinct step. In another embodiment, although depicted as distinct steps in FIGS. 4A and 4B the steps of method of FIGS. 4A and 4B may not be distinct steps. In other embodiments, the method of FIGS. 4A and 4B may not have all of the above steps and/or may have other steps in addition to or instead of those listed above. The steps of method of FIG. 4A and 4B may be performed in another order. Subsets of the steps listed above as part of method of FIGS. 4A and 4B may be used to form their own method.

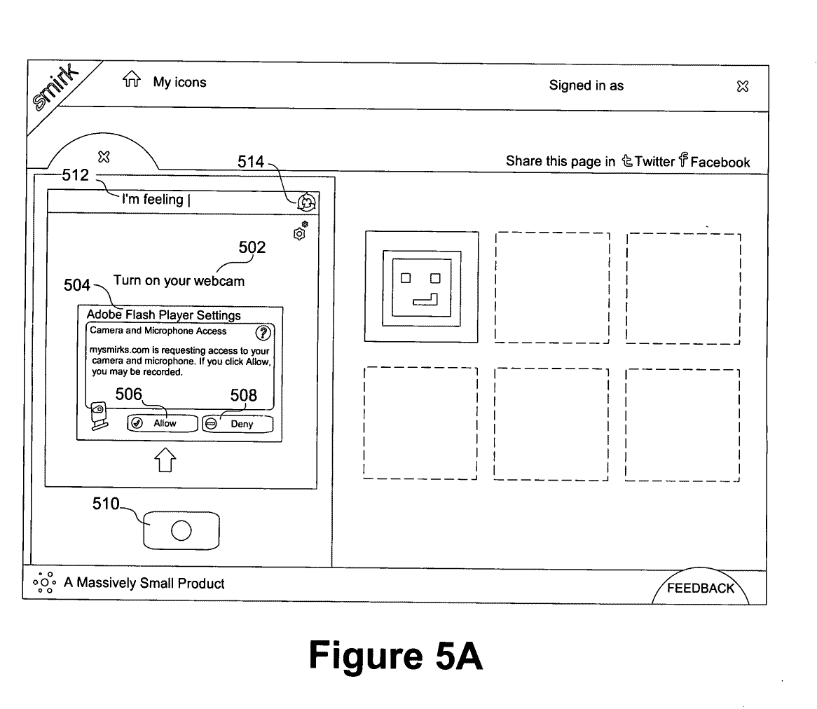

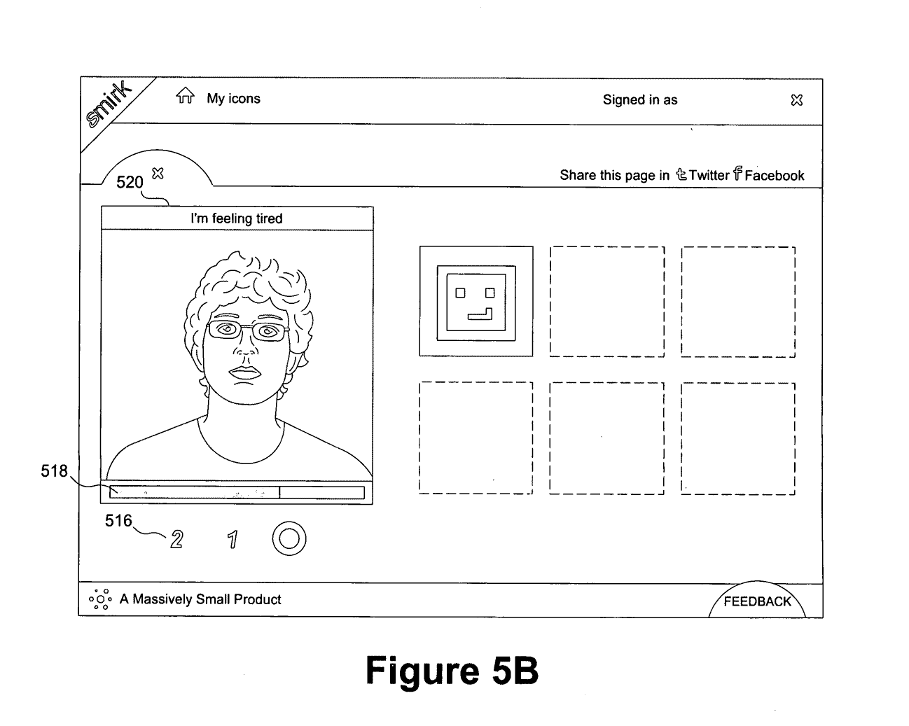

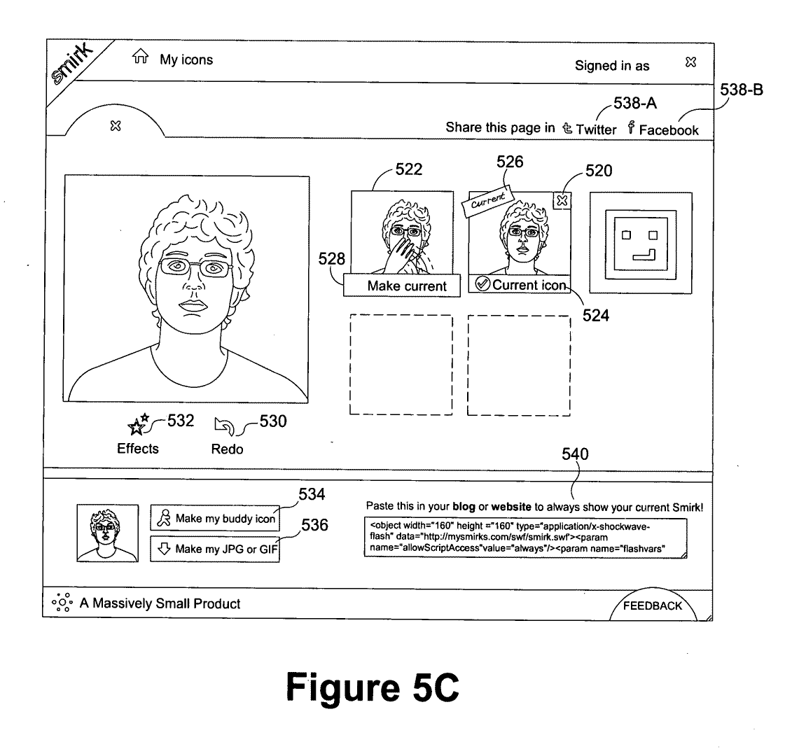

FIGS. 5A-5C illustrate an example of a user interface for creating a dynamic visual representation. FIG. 5A shows an example a page of a user interface including at least instructions 502, and an option 504 to allow 506 or deny 508, record button 510, text entry region 512, and standard statuses 514. In other embodiments the page of FIG. 5A may not have all of the elements or features listed and/or may have other elements or features instead of or in addition to those listed.

As illustrated in FIG. 5A, in some embodiments, before the script/object is activated a user is presented with instructions to turn on the camera 502 and an option 504 to allow 506 or deny 508 the script/object to access the attached camera. In some embodiments the script/object is automatically granted access to the attached camera 315. Once the script/object is active, the user may be presented with a record button 510 for initiating the capture of video data. In some embodiments the user is also simultaneously presented with the option to select a status. In one embodiment, the option to select a status includes a text entry region 512 for creating a status by entering text. In other embodiments a menu, drop down list or the like is used. In some embodiments the user is presented with a button for generating a random status from a set of standard statuses 514. For example, a user can generate a random status and then capture video data indicative of that status. The status may be selected by the user from a list including standard statuses, the statuses created by the first user and/or statuses created by other users. In some embodiments, a status is a word or phrase describing an emotional state of a user. In some embodiments, after the camera has been invoked, a user can create a new status and perform an operation to begin capturing video data from the camera 315, such as selecting a record button 510 on the user interface. For example, a user may select a record button on a user interface in the web browser or the video capture may start automatically after the status is selected by the user.

FIG. 5B illustrates one example of an embodiment of a page of a user interface capturing video data. The user interface of FIG. 5B includes countdown 516, progress bar 518, and image 520. In other embodiments the page of FIG. 5B may not have all of the elements or features listed and/or may have other elements or features instead of or in addition to those listed.

In some embodiments, a visual indicator of the recording is provided to the user. For example, a countdown 516 may be displayed in the website to indicate that video data is about to be captured or that video is currently being captured, such as when a user selects the record button, a countdown from 2 to 0 begins and recording starts at the end of the countdown. In some embodiments, while the video data is being captured a visual indicator, such as a progress bar 518, is displayed to the user which includes an indication of the amount of recording time remaining. In some, embodiments the selected status is displayed in image 520 while the video data is being captured. In some embodiments, image 520 displays the video data being received by camera 315 as the video data is being recorded. In some embodiments, capturing video includes capturing a series of still images that are stored as separate image files. In some embodiments, capturing video includes capturing a single video file. In some embodiments, the video data is a file, while in other embodiments the video data is a data stream.

FIG. 5C illustrates an example of an embodiment of a page of a user interface for managing dynamic visual representations. The page of the user interface of FIG. 5C may include dynamic visual representations 522, 524, visual indicator 526, button 528, redo button 530, effects button 532, avatar or buddy icon 534, dynamic visual representation 536, TWITTER 538-A or FACEBOOK 538-B, and a embed code 540. In other embodiments the page of FIG. 5C may not have all of the elements or features listed and/or may have other elements or features instead of or in addition to those listed.

In some embodiments, the user is presented with options for managing multiple stored dynamic visual representations 522, 524. In some embodiments the current dynamic visual representation has a visual indicator 526 indicating that the dynamic visual representation is the current dynamic visual representation. In some embodiments one or more of the dynamic visual representations that are not the current dynamic visual representation include a button 528 that allows the user to set the dynamic visual representation as the current dynamic visual representation. In other embodiments a drop down menu, scrolling list or the like is provided to the user to select a current status. In some embodiments a user selects a redo button 530 to replace the dynamic visual representation associated with a status. In some embodiments a user adds visual effects to a dynamic visual representation by selecting an effects button 532.

In some embodiments a user is provided with one or more options for sharing the user's dynamic visual representations with other users. For example, a user may make one of the dynamic visual representations an instant messenger avatar or buddy icon 534, download a file including a dynamic visual representation 536, share one or more of the dynamic visual representations through a social networking website, such as TWITTER 538-A or FACEBOOK 538-B, embed code 540 may provide a user with a link and a code, such as HTML or other browser code, for inserting a dynamic visual representation, such as the current dynamic visual representation in a website or other electronic document.

FIG. 6A illustrates an example of a page of a user interface for changing the current status of a user in accordance with some embodiments of the present invention. The embodiment of the user interface of FIG. 6A includes plurality of dynamic visual representations 602, sad 604, chipper 606, new dynamic visual representation 608, button 610, settings button 612, my moods button 614, and button 616. In other embodiments the page of FIG. 6A may not have all of the elements or features listed and/or may have other elements or features instead of or in addition to those listed.

In the example of FIG. 6A, in an embodiment, a plurality of dynamic visual representations 602 are displayed on the screen, each dynamic visual representation having an associated status. For example, the user may select sad 604 or chipper 606 as a current status. The dynamic visual representation associated with the status set by the user will then be the current dynamic visual representation for the user. In some embodiments, a user is presented with the option to create a new dynamic visual representation 608.

In some embodiments, when a selected status is identified as a current status, the dynamic visual representation associated with the current status is sent to one or more computing devices. For example, if the second user has the first user as her or his current contact and the first user updates his or her current status to “happy”, then the server sends the dynamic visual representation associated with the current “happy” status of the first user to the second user, so that when the second user views the dynamic visual representation of the first user, the current “happy” dynamic visual representation of the first user is displayed. In another embodiment, the computing device associated with the second user may periodically check with the DVR server system 106 to determine whether the status of any of a subset of users has changed in a predefined time period, such as the last time the computing device checked with the server system 106. In some embodiments, the computing device may then request updated dynamic visual representations for any users whose status has changed within the predefined time period. For example, if a user has a cell phone with an address book application that includes dynamic visual representations, the cell phone may periodically check with the DVR server system 106 to determine whether any of the user's contacts have updated their status and download the current dynamic visual representation for any contact that has an updated status.

In some embodiments, the default may be that the current status is the status associated with the last dynamic visual representation that was created. This embodiment may be useful for users that frequently update their dynamic visual representations. For example, a user may create a new dynamic visual representation everyday by capturing video data of the user's facial expression, thus creating a diary of facial expressions over a period of time. In this example, the user may want the most recent facial expression to always be identified as the current status of the user. Thus, automatically identifying the most recently created dynamic visual representation as a current dynamic visual representation saves the user the time it would take to individually indicate that a new dynamic visual representation is the current dynamic visual representation. In some embodiments, the dynamic visual representations are displayed to the user in the order in which they were created. In some embodiments, the current dynamic visual representation is highlighted. Highlighting refers to any method of visually distinguishing an element in the user interface, including changing the color, contrast or saturation as well as surrounding the element with a perimeter of a different color or underlining the element.

In some embodiments, the display may also have one or more buttons for navigating through the user interface, such as a contacts button 610 that selects and invokes to an address book, as described in greater detail in conjunction with FIG. 6C, below. A settings button 612 may also be provided that invokes a settings page, as described in greater detail in conjunction with FIG. 6F, below, while a my moods button 614 is highlighted to indicate that the my mood page is the currently displayed page and a top contacts button 616 invokes a top contacts page that are both described in more detail below in conjunction with FIG. 6B, below. In some embodiments, upon receiving a selection of one of these buttons, the computing device may also display the user interface associated with the selected button.

As used in the present application, a contact application is any application that includes a representation of the contacts of a user. Contacts of a user are entities, such as friends, family members and businesses, for whom the user has at least one piece of contact information, such as a phone number, address, e-mail or network account identifier. In some embodiments, multiple dynamic visual representations in which each representation of a status of a distinct contact of the user are sent to the computing device associated with the user and a plurality of the multiple dynamic visual representations are displayed simultaneously on the computing device. In some embodiments, the computing device is a portable electronic device, such as a BlackBerry™ or a cell phone. In some embodiments, a contact application has a user interface such as illustrated in FIG. 6B, where the plurality of the multiple dynamic visual representations are displayed simultaneously in a matrix of (or list of) dynamic visual representations. Displaying a matrix (or list) of dynamic visual representations of a plurality of distinct users or contacts provides the user with the ability to quickly review the current status of the plurality of contacts. For example, the user can quickly look at the dynamic visual representations and see that one of the contacts has a current dynamic visual representation that indicates that the contact is sad, while another one of the contacts has a current dynamic visual representation that indicates that the contact is happy. The user may decide to call the contact having a current dynamic visual representation that indicates that the contact is sad to find out why the user is sad.

FIG. 6B illustrates current dynamic visual representations of each of a plurality of contacts of a user simultaneously displayed in accordance with some embodiments of the present invention. The embodiment illustrated in FIG. 6B, may include plurality of contacts 618, the current dynamic visual representation 620, and dynamic visual representation 622. In other embodiments, the page of FIG. 6B may not have all of the elements or features listed and/or may have other elements or features instead of or in addition to those listed.

In the embodiment illustrated in FIG. 6B, the current dynamic visual representations of each of a plurality of contacts 618 of a user (e.g., eight contacts surrounding a dynamic visual representation of the user) are displayed simultaneously. In some embodiments, these contacts are the top contacts of the user. In some embodiments top contacts are selected by the user. In other embodiments top contacts are automatically selected by the computing device or the DVR server system 106 based on the frequency of communication between the user and the contact, such as the contacts that the user communicates with the most frequently, the contacts the user communicates most frequently within the last month, the contacts that the user most frequently initiates communication with or the most recent contacts that the user has communicated with. In some embodiments, the current dynamic visual representation of the user 620 is displayed in the user interface. In some embodiments, selecting the dynamic visual representation of one of the contacts takes the user to a contact information page for the user, as described in greater detail in conjunction with FIG. 6D, below. In some embodiments, selecting the dynamic visual representation 622 associated with one of the contacts sends a request to initiate communication to that user. For example, a user could call a contact by simply selecting the dynamic visual representation 622 without navigating through any other menus. In some embodiments, a request to initiate communication with the contact includes sending a notification to the DVR server system 106 that a communication initiation request has been made, as subsequently described in greater detail. In some embodiments, selecting the dynamic visual representation of the user takes the user to an interface for changing the user's dynamic visual representation, such as selecting a current status or creating a new dynamic visual representation, as previously discussed in conjunction with FIG. 6A. In some embodiments, the user interface may also include one or more buttons 610, 612, 614, 616 for navigating through the user interface, as discussed previously in conjunction with FIG. 6A.

FIGS. 6C1 and 6C2 illustrate an embodiment where the contact application is an address book application. FIGS. 6C1 and 6C2 may include search 624, name of contact 626, dynamic visual representation of one or more contact 628, sad status 630, contact 632, and contact 634. In other embodiments, the pages of FIGS. 6C1 and 6C2 may not have all of the elements or features listed and/or may have other elements or features instead of or in addition to those listed.

In some embodiments, displaying the dynamic visual representations of the users includes displaying the dynamic visual representation of one or more contacts 624 in a list along with identifying information such as a name of the contact 626 associated with the dynamic visual representation. In some embodiments, the address book application also includes an indication of other information associated with the contact 628, such as how many electronic communications the user has missed from that particular contact. The address book may also contain other functions such as a search function that allows the user to search within the contact list. In some embodiments, the dynamic visual representations display a moving image only the first time they are loaded and thereafter display a still image. In some embodiments, the still image is a frame from the dynamic visual representation. In other embodiments the icons continuously display a moving image while in some embodiments the dynamic visual representations are continuously animated while they are displayed.

In some embodiments, the DVR server system 106 sends a plurality of dynamic visual representations representative of a distinct status of a contact of the user to the computing device for display in an application on the computing device. In some embodiments the distinct statuses include at least a default status and a reaction status, such that the default status is initially displayed and when the second user performs an operation associated with the first user, the reaction status is displayed. For example, if the user has missed three electronic communications from Jack Adams, the dynamic visual representation of Jack Adams may be the dynamic visual representation for the sad status 630. In some embodiments, if the user then selects the contact 632, such as Jack Adams, then the dynamic visual representation for that contact reacts (e.g., by the dynamic visual representation associated with the “sad” status is replaced with the dynamic visual representation associated with the “happy” status). In some embodiments, selecting the dynamic visual representation of one of the contacts 634 takes the user to a contact information page for the user (described in greater detail below with reference to FIG. 6E). In some embodiments selecting the dynamic visual representation of one of the contacts 622 initiates contact with the user. In some embodiments, the display of the reaction status is based on a predefined condition being met. For example, at a certain time each day a user's status might change to sleeping after being awake all day. In some embodiments, the user interface may also include one or more buttons 610, 612, 614, 616 for navigating through the user interface, as discussed previously with reference to FIG. 6A.

FIG. 6D illustrates an example of a page of a user interface for displaying additional contact information in accordance with some embodiments of the present invention. The page of the user interface of FIG. 6D may include phone 638, by text message 640, e-mail 642, other communication services 644, video sharing services 646, blogs 650, and contact 652. In other embodiments, the pages of FIGS. 6C1 and 6C2 may not have all of the elements or features listed and/or may have other elements or features instead of or in addition to those listed.

An example of a user interface for displaying additional contact information is also illustrated in FIG. 6D. In some embodiments, the interface includes the dynamic visual representation of the contact. In some embodiments, the user is presented with one or more options for initiating communication with the contact, such as by phone 638, by text message 640 or by e-mail 642. In other embodiments, a user may enter contact information (e.g., dial a telephone number) or select the name of a contact from a list of names. In some embodiments, the user is not presented with a dynamic visual representation of the contact until a request to initiate communication has been sent to the contact, such as when the dynamic visual representation is only shown after a user dials the phone number of a contact and presses the send button. In some embodiments, the additional communication information also includes other communication services 644, such as TWITTER, video sharing services 646, such as UOOO, photo sharing services 648, such as FLICKR, blogs 650 and links to other online information about the contact 652 (e.g., a link to the contact's company), or a social networking site (e.g., FACEBOOK). In some embodiments, the additional communication information is information that the contact has shared with the DVR server system 106. In some embodiments, the additional communication is information that the user has entered, such as a home address, relationship to other contacts, phone numbers, e-mail addresses and other pertinent information. In some embodiments, the user interface may also include one or more buttons 610, 612, 614, 616 for navigating through the user interface, as discussed previously in conjunction with FIG. 6A.

FIG. 6E illustrates an example of a user interface for implementing the method described herein for receiving a request to initiate communication from a second user. In an embodiment, the page of the interface of FIG. 6E may include display of the computing device 654, name of the second user 656, initiation of communication 658, status of the second user 660, request 662, and request 664. In other embodiments, the page of FIG. 6E may not have all of the elements or features listed and/or may have other elements or features instead of or in addition to those listed.

In some embodiments, the dynamic visual representation of the second user is displayed on a display of the computing device 654. Additional communication information that is displayed with the dynamic visual representation of the second user may include the name of the second user 656, the type of computing device that the second user is using to request the initiation of communication 658, an additional indicator of the status of the second user 660 (e.g., text stating the status of the user), and any other communication information that would be useful to the first user when deciding how to respond to the request to initiate communication.

The dynamic visual representation may quickly provide the first user (e.g., the call recipient) with information about the status of the second user (e.g., the call initiator), such as the emotional state of the second user. The status information can be used by the first user to determine how to respond to the request from the second user. For example, if the first user receives a call from the second user and sees that the dynamic visual representation of the second user indicates that the user is in an angry emotional state, the first user may choose not to answer the call. In another example, the first user may receive a call from the second user while the first user is in a meeting and may decide to take the call if it is urgent (e.g., the dynamic visual representation of the second user indicates that the second user is in a “sad” emotional state), but may decide not to answer the call if it is not urgent (e.g., the dynamic visual representation of the second user indicates that the user is in a “happy” emotional state).

In some embodiments, the user interface for receiving a request to initiate communication includes an option to ignore the request 662 and an option to accept the request 664. In some embodiments, before the user has selected an option, the dynamic visual representation is continuously animated (e.g., the video is repeated in a continuous loop or the images are displayed in a repeating sequence) while the request to initiate communication is pending, such as when the phone is ringing. In some embodiments, selecting the option to ignore the request returns the computing device to an idle state. In some embodiments, selecting the option to ignore the request takes the user to a user interface that contains additional communication information associated with the second user, such as the user interface described in greater detail above with reference to FIG. 6D. From the additional communication page, the user may be presented with options for sending a reply to the second user using an alternate mode of communication. For example, the first user may receive a request to initiate a phone call with the second user and select the ignore option and be presented with the option to send a text message or e-mail to the second user explaining why the user ignored the call (e.g., the first user was in a meeting). Alternatively, the first user may also choose to accept the request to initiate communication.

FIG. 6F illustrates a user interface for adjusting the settings of the computing device, in accordance with some embodiments of the present invention. In addition to typical settings for controlling a computing device, these settings may include determining the frequency with which the device checks for new dynamic visual representations of the contacts of a user. In some embodiments, settings include an option to set the most recently created dynamic visual representation of the user as the current dynamic visual representation of the user. In some embodiments, the settings include settings for determining what contact information about the user to share with other users. In some embodiments, the settings include settings for automatically changing the dynamic visual representation associated with the user based on user defined criteria, such as the time of day, the day of the week, events in a user's calendar and other desired criteria. In some embodiments, the user interface may also include one or more buttons 610, 612, 614, 616 for navigating through the user interface, as discussed previously with reference to FIG. 6A.

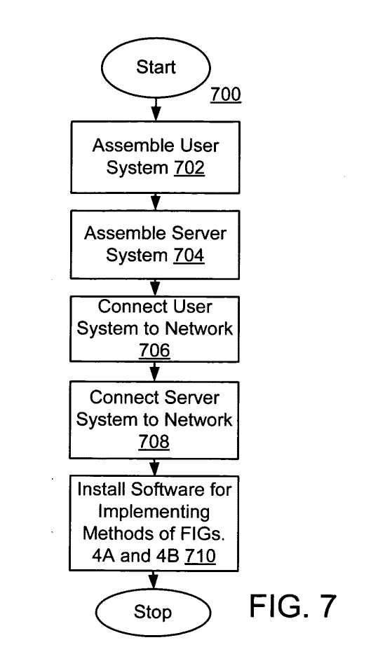

FIG. 7 is a method of assembling distributed system 100, in step 702, user systems (FIGS. 1) are assembled, which may include communicatively coupling one or more processors, one or more memory devices, one or more input devices (e.g., one or more mice, keyboards, keypads, microphones, cameras, antenna, and/or scanners), one or more output devices (e.g., one more printers, one or more interfaces to networks, speakers, antenna, and/or one or more monitors) to one another.

In step 704, dynamic visual server system 106 (FIG. 1) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 106 may include installing.

In step 706, the user systems are communicatively coupled to network 104. In step 708, server system 106 is communicatively coupled to network 104 allowing the user system and server system 106 to communicate with one another (FIG. 1). In step 710, one or more instructions may be installed in server system 106 (e.g., the instructions may be installed on one or more machine readable media, such as computer readable media, therein) and/or server system 106 is otherwise configured for performing the steps of the methods of FIGS. 4A and 4B. For example, as part of step 710, one or more machine instructions may be entered into the memory of system 206 for storing, retrieving and/or indication of a user's emotional status, such as dynamic visual representations, and/or other user information. Similarly, one or more machine instructions may be entered into memory 306 for creating, requesting from the server system 106, and/or sending to the server system 106 indications of the user's status and/or other information. Use of the server system 106 is optional. User devices could exchange and update status indicators (e.g., dynamic visual representations) directly with one another. Use of the server system 106 allows the users to update their own status indicators and/or retrieve updates for other users' status indicators without regard to whether the other users currently have their respective user devices connected to network 104. The software only needs to be installed on the receiver's device or caller's device. Use of server system 106 allows status indicators to be embedded in electronic documents, and allows the electronic documents to retrieve updates for the status indicators.

In another embodiment, although depicted as distinct steps in FIG. 7, steps 702-710 may not be distinct steps. In other embodiments, method 700 may not have all of the above steps and/or may have other steps in addition to, or instead of, those listed above. The steps of method 700 may be performed in another order. Subsets of the steps listed above as part of method 700 may be used to form their own method.

### Alternatives and Extensions

The above embodiments have been described with respect to establishing contact between a first user and a second user; however it should be understood that dynamic visual representations have applications in addition to those disclosed above. In some embodiments, a dynamic visual representation of a user is embedded in a web page and indicates a status of the user associated with the dynamic visual representation. For example, the dynamic visual representation could be embedded in a social networking website. In this example, the contacts of the user (e.g., other users of the social networking would be able to view the dynamic visual representation. In some embodiments, the user may choose to set a dynamic visual representation as the current dynamic visual representation. In these embodiments, when the user changes the current dynamic visual representation of the user (e.g., creates a new dynamic visual representation or changes the current status of the user from “happy” to “sad.”), the dynamic visual representation of the user changes on the website having the embedded dynamic visual representation of a user.

In some embodiments, the user embeds the current dynamic visual representation on a plurality of web pages. Thus, when the user changes the user's current status, the dynamic visual representation of the user on each web page changes to the updated current dynamic visual representation.

In some embodiments, a web page may initially display the current dynamic visual representation of a user and may include a script or object that causes a first dynamic visual representation to be displayed after the occurrence of a first event and a second dynamic visual representation to be displayed after the occurrence of a second event. For example, in one embodiment, a user sends out an electronic invitation including a default dynamic visual representation (e.g., the current dynamic visual representation) that is displayed when one of the recipients initially views the invitation. In response to an action taken by the recipient (e.g., replying to the initiation), the dynamic visual representation of the user changes to either the first dynamic visual representation or the second dynamic visual representation (e.g., if the response is “I cannot attend”). In this example, if the recipient responds with “I can attend” the predetermined dynamic visual representation is the dynamic visual representation associated with the “happy” status of the user, whereas if the recipient responds “I cannot attend” the predetermined dynamic visual representation is the dynamic visual representation associated with the “sad” status of the user.

Although FIGS. 1-3 show various computing devices including a DVR server system 106 and a client device 102, FIGS. 1-3 are intended more as a functional description of the various features which may be present in a set of servers than as a structural schematic of the embodiments described herein. In practice and as recognized by those of ordinary skill in the art, items shown separately could be combined and some items could be separated. Each of the above elements identified in FIGS. 2-3 may be stored in one or more of the previously mentioned memory devices and correspond to a set of instructions for performing a function described above. The above identified modules or programs need not be implemented as separate software programs, procedures or modules and thus various subsets of these modules may be combined or otherwise rearranged in various embodiments. For example, some items shown separately in FIG. 2 could be implemented on a single server and single items could be implemented by one or more servers. Similarly, some items shown separately in FIG. 3 could be implemented on a single server and single items could be implemented by one or more servers. The actual number of computing devices used to implement a DVR server system 106 or a client system 102 and how features are allocated among them will vary from one implementation to another and may depend in part on the amount of data traffic that the system must handle during peak usage periods as well as during average usage periods.

In some embodiments, a method is implemented for providing a dynamic visual representation of a status of one or more users, may include, for each of the one or more users, and obtaining, at a server system, from a first computing device associated with a first user, multiple dynamic visual representations (and storing the dynamic visual representation obtained), where each of which is associated with a distinct status of the first user. Receiving, at the server system, from a second computing device, a status request for a desired status of the first user. Selecting, in response to the status request, a selected dynamic visual representation associated with a status of the first user indicated by the status request. Transmitting the selected dynamic visual representation from the server system to the second computing device for display.

In some embodiments, the status request includes a desired status of the first user and the selecting may further include selecting the desired status of the first user. In some embodiments, distributed system 100 identifies one of the multiple dynamic visual representations as a current dynamic visual representation. In some embodiments, distributed system 100 receives, from the first user a selection of one of the dynamic visual representations as a current dynamic visual. In some embodiment the selecting further includes selecting the selected dynamic visual representation that is associated with a desired status of the first user when the request indicates the desired status; and selecting the current dynamic visual representation as the selected dynamic visual representation when the request does not indicate a desired status of the first user. In some embodiments distributed system 100 sends the current dynamic visual representation to one or more computing devices, including the second computing device, when a current dynamic visual representation is identified.

In some embodiments, a dynamic visual representation of a user is representative of an emotional state of the user. In some embodiments, obtaining a dynamic visual representation of a status of a user includes receiving, at the server system, from the first computing device associated with the first user, a respective status of the first user and video data associated with the respective status, transcoding at least a predefined portion of the video data, associating the transcoded video data with the respective status, and storing the transcoded video data and the respective status on the server system.

In some embodiments, transcoding at least a predefined portion of the video data includes encoding the predefined portion of the video data as a video file. In some embodiments, the transcoding further includes extracting a consecutive series of frames in the predefined portion of the video data, storing the frames on the server system; and encoding the plurality of frames.

In some embodiments, the transmitting further includes sending the frames to the second computing device such that the series of frames are rapidly displayed so as to give the impression of a moving image. In some embodiments, the video data is captured by a webcam or other camera. In some embodiments, the video data is a stream. In some embodiments, the video data is a file. In some embodiments, the distributed system 100, prior to the transmitting, receives, at a server system, an initiation notification from the second user indicating that the second user has attempted to initiate communication with the first user; wherein the transmitting further includes, in response to the initiation notification, sending a dynamic visual representation of a status of the first user to the second user, for display.

In some embodiments, the distributed system 100 obtains, at the server system, from a second computing device associated with a second user, multiple dynamic visual representations, each of which is associated with a distinct status of the second user (and stores the dynamic visual representation obtained). In some embodiments, in response to the initiation notification, distributed system 100 sends a dynamic visual representation of a status of the second user to the first user, for display. In some embodiments, the distributed system 100 receives, at the server system, from the first user, a request for a status of the second user; and in response to the request, sending a dynamic visual representation of a status of the second user to the first user, for display.

According to one embodiment, a distributed system 100 provides a dynamic visual representation of a status of one or more users. For each of the one or more users: distributed system 100 creates, at a first computing device, video data for use by a server system to create dynamic visual representations, each of which is associated with a distinct status of the first user. Distributed system 100 sends, from a second computing device, to the server system, a status request for a desired status of the first user; and receives, in response to the status request, a dynamic visual representation associated with a status of the first user indicated by the status request. Distributed system 100 displays the received dynamic visual representation.

According to some embodiments, distributed system 100 provides a dynamic visual representation of a status of one or more users. For each of the one or more users, distributed system 100, at the server and obtains, at a server system, from a first computing device associated with a first user, multiple dynamic visual representations (and stores the dynamic visual representation obtained), each of which is associated with a distinct status of the first user. Distributed system 100 obtains, at the server system, from a second computing device associated with a second user, multiple dynamic visual representations (and stores the dynamic visual representation obtained), each of which is associated with a distinct status of the second user. Distributed system 100 receives, at a server system, an initiation notification from the second user indicating that the second user has attempted to initiate communication with the first user; and transmits, in response to the initiation notification, a dynamic visual representation of a status of the first user to the second user, for display. In some embodiments, in response to the initiation notification, distributed system 100 sends a dynamic visual representation of a status of the second user to the first user, for display. In some embodiments, distributed system 100 receives, at the server system, from the first user, a request for a status of the second user; and in response to the request, sending a dynamic visual representation of a status of the second user to the first user, for display.

In some embodiments, prior to the receiving, distributed system 100 sends, to the second user, multiple dynamic visual representations each representative of a status of a distinct user to an application on the second computing device such that a plurality of the multiple dynamic visual representations are displayed simultaneously on the computing device. In some embodiments, the second computing device is a portable electronic device, and the application is an address book. In some embodiments, the multiple dynamic visual representations are displayed simultaneously in a matrix of dynamic visual representations. The matrix may have one or more rows and one or more columns (e.g. two or more rows and two or more columns). In some embodiments, distributed system 100 sends, to the second user, a plurality of dynamic visual representations each representative of a distinct status of the first user to an application on the second computing device, the distinct statuses including at least a default status and a reaction status; such that the default status initially displayed, and when the second user performs an operation associated with the first user, the reaction status is displayed.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising, for each of one or more users:
storing, on a storage device of a server system, multiple dynamic visual representations, each of which is associated with a distinct status of the first user, the server system including at least a processor and the storage device being communicatively linked to the processor;
receiving, at the server system, from a second computing device, a status request for a status of the first user; and
selecting, in response to the status request, a selected dynamic visual representation associated with a status of the first user indicated by the status request; and
transmitting the selected dynamic visual representation from the server system to the second computing device for display.

2. The method of claim 1, wherein the status request includes a desired status of the first user and said selecting further comprises selecting the desired status of the first user.

3. The method of claim 1, further comprising:
receiving, from the first user, a selection of one of the dynamic visual representations as a current dynamic visual.

4. The method of claim 1, further comprising:
identifying one of the multiple dynamic visual representations as a current dynamic visual representation;
selecting the selected dynamic visual representation that is associated with a desired status of the first user when the request indicates the desired status; and
selecting the current dynamic visual representation as the selected dynamic visual representation when the request does not indicate a desired status of the first user.

5. The method of claim 4, further comprising:
when a current dynamic visual representation is identified, sending the current dynamic visual representation to one or more computing devices, including the second computing device.

6. The method of claim 1, wherein the selected dynamic visual representation includes at least information representative of an emotional state of the first user.

7. The method of claim 1, further comprising:
obtaining a dynamic visual representation of a status of a user by at least receiving, at the server system, from the first computing device associated with the first user, the status of the first user and video data associated with the status;
transcoding at least a predefined portion of the video data;
associating the transcoded video data with the status; and
placing the transcoded video data and the status on the server system at a storage location on one or more computer readable media of the storage device.

8. The method of claim 7, wherein transcoding at least a predefined portion of the video data includes encoding the predefined portion of the video data as a video file.

9. The method of claim 7, the transcoding further comprises:
extracting a consecutive series of frames in the predefined portion of the video data; and
placing the frames at the storage location.

10. The method of claim 9, the transmitting further comprising sending the frames to the second computing device such that the series of frames are rapidly displayed so as to give the impression of a moving image.

11. The method of claim 7, the video data is captured by a webcam.

12. The method of claim 11, wherein the video data is a stream.

13. The method of claim 11, wherein the video data is a file.

14. The method of claim 1, further comprising, prior to the transmitting:
receiving, at a server system, an initiation notification from the second user indicating that the second user has attempted to initiate communication with the first user; and
the transmitting includes at least, in response to the initiation notification, sending the selected dynamic visual representation of the status of the first user to the second user, for display.

15. The method of claim 14, further comprising:
storing, at the server system, multiple dynamic visual representations, each of which is associated with a distinct status of the second user.

16. The method of claim 15, further comprising:
in response to the initiation notification, sending a dynamic visual representation of a status of the second user to the first user, for display.

17. The method of claim 15, further comprising:
receiving, at the server system, from the first user, a request for a status of the second user; and
in response to the request, sending a dynamic visual representation of a status of the second user to the first user, for display.

18. The method of claim 15, further comprising:
in response to the initiation notification, sending a dynamic visual representation of a status of the second user to the first user, for display.

19. The method of claim 15, further comprising:
receiving, at the server system, from the first user, a request for a status of the second user; and
in response to the request, sending a dynamic visual representation of a status of the second user to the first user, for display.

20. The method of claim 15, further comprising, prior to the receiving:
sending, to the second user, multiple dynamic visual representations each representative of a status of a distinct user to an application on the second computing device such that a plurality of the multiple dynamic visual representations are displayed simultaneously on the computing device.

21. The method of claim 26, wherein the second computing device is a portable electronic device, and the application is an address book.

22. The method of claim 26, wherein the multiple dynamic visual representations are displayed simultaneously in a matrix of dynamic visual representations.

23. The method of claim 15, further comprising:
sending, to the second user, a plurality of dynamic visual representations each representative of a distinct status of the first user to an application on the second computing device, the distinct statuses including at least a default status and a reaction status; such that the default status initially displayed, and when the second user performs an operation associated with the first user the reaction status is displayed.

24. A server system, comprising:
one or more processors; and
a memory unit having one or more computer readable media storing one or more machine instructions, which when invoked cause the one or more processors to implement a method including at least
storing, at a server system, multiple dynamic visual representations, each of which is associated with a distinct status of a first user;
receiving, at the server system, from a second computing device, a status request for a status of the first user; and
selecting, in response to the status request, a selected dynamic visual representation associated with a status of the first user indicated by the status request; and
transmitting the selected dynamic visual representation from the server system to the second computing device for display.

25. A computer readable storage medium storing one or more machine instructions, which when invoked cause one or more processors of a server system to implement a method comprising:
storing, at a server system, multiple dynamic visual representations, each of which is associated with a distinct status of a first user, the server system including at least a processor and the storage device being communicatively linked to the processor;
receiving, at the server system, from a second computing device, a status request for a status of the first user; and
selecting, in response to the status request, a selected dynamic visual representation associated with a status of the first user indicated by the status request; and
transmitting the selected dynamic visual representation from the server system to the second computing device for display.

26. A method comprising:
receiving, at a first phone device, a signal indicating an incoming phone call from a second phone device of a caller; and
prior to answering the phone call, displaying on a display of the phone device an indication of the an emotional state of the caller.

27. A method comprising:
receiving, at a first phone device, a signal indicating an incoming phone call from a second phone device of a caller; and
in response, prior to the phone call being answered, displaying on a display of the first phone device an indication of the an emotional state of the caller.

28. A method comprising:
receiving, at a network device, input from a user, via an input device communicatively linked to the network device, the input requesting access to an address list; and
in response, displaying on a display of the network device the address list by at least displaying a list of address that includes for each address of a plurality of addresses of the address list an indication of a current emotional status associated with the address.

29. The method of claim 28, further comprising: prior to displaying the address list, for each address of the plurality of addresses, the network device automatically requesting the current emotional associated with the address, so that the current emotional status is up-to-date while displaying the address list.
